(19) United States
(12) Patent Application Publication
(10) Pub. No.: US 2026/0343376 A1
(43) Pub. Date: Oct. 29, 2026

(54) MULTI-LINK DEVICE COMMUNICATION METHOD AND RELATED DEVICE

(71) Applicant: Tencent Technology (Shenzhen) Company Limited, Shenzhen (CN)

(72) Inventor: Qiang XIE, Shenzhen (CN)

(73) Assignee: Tencent Technology (Shenzhen) Company Limited, Shenzhen (CN)

(21) Appl. No.: 19/704,605

(22) Filed: Jun. 11, 2026

Related U.S. Application Data
(63) Continuation of application No. PCT/CN2025/076186, filed on Feb. 7, 2025.

(30) Foreign Application Priority Data
Mar. 5, 2024 (CN) 202410254637.7

(51) Int. Cl. H04W 40/02; H04L 45/243

(52) U.S. Cl. CPC H04W 40/02; H04L 45/243

(57) ABSTRACT

A multi-link device communication method, apparatus, and computer-readable storage medium for adaptive traffic management across multiple links. A first multi-link device determines that a first link transmitting traffic data to a second multi-link device is in a first state indicating low channel quality or congestion. In response, the first device generates and transmits a first request frame requesting the second device to map a traffic identifier of the traffic data to at least two links. Upon receiving a first response frame indicating acceptance, the traffic data is simultaneously transmitted over the at least two links, and the mapping of the traffic identifier is updated from the first link to the multiple links. This approach enables parallel data transmission across links to maintain reliable communication when individual links experience degradation.

### CROSS-REFERENCE TO RELATED APPLICATIONS

This application is a continuation application of International Application No. PCT/CN2025/076186 filed on Feb. 7, 2025 which claims priority to Chinese Patent Application No. 202410254637.7, filed with the China National Intellectual Property Administration on Mar. 5, 2024, the disclosures of each being incorporated by reference herein in their entireties.

### FIELD

The disclosure relates to the field of communication technologies, a multi-link device communication method, a multi-link device, a computer-readable storage medium, and a computer program product.

### BACKGROUND

The Institute of Electrical and Electronics engineers (IEEE) has developed the IEEE 802.11be protocol standard for wireless local area networks (WLANs), which introduces a multi-link (ML) mechanism. A multi-link device (MLD) can support data transmission over a plurality of links.

### SUMMARY

Provided are a multi-link device communication method and apparatus, a device, a storage medium, and a program product, which can implement reliable data transmission through adaptive traffic remapping across multiple links based on link state monitoring.

According to some embodiments, a multi-link device communication method, performed by a first multi-link device, includes: determining that a first link transmitting traffic data between the first multi-link device and a second multi-link device is in a first state, wherein the first state indicates that the first link has channel quality lower than a threshold or is congested; generating, in response to the first link being in the first state, a first request frame requesting the second multi-link device to map a first traffic identifier of the traffic data to at least two links between the first multi-link device and the second multi-link device; transmitting the first request frame to the second multi-link device; receiving a first response frame returned by the second multi-link device in response to the first request frame; and simultaneously transmitting the traffic data over the at least two links based on the first response frame indicating that the second multi-link device accepts the first request frame, and updating a mapping of the first traffic identifier from the first link to the at least two links, such that the traffic data is transmitted in parallel over the at least two links while the first link is in the first state.

According to some embodiments, a multi-link device communication apparatus, includes: at least one memory configured to store program code; and at least one processor configured to read the program code and operate as instructed by the program code, the program code including: determination code configured to cause at least one of the at least one processor to determine that a first link transmitting traffic data between a first multi-link device and a second multi-link device is in a first state, wherein the first state indicates that the first link has channel quality lower than a threshold or is congested; generation code configured to cause at least one of the at least one processor to generate, in response to the first link being in the first state, a first request frame requesting the second multi-link device to map a first traffic identifier of the traffic data to at least two links between the first multi-link device and the second multi-link device; transmission code configured to cause at least one of the at least one processor to transmit the first request frame to the second multi-link device; reception code configured to cause at least one of the at least one processor to receive a first response frame returned by the second multi-link device in response to the first request frame; and mapping code configured to cause at least one of the at least one processor to simultaneously transmit the traffic data over the at least two links based on the first response frame indicating that the second multi-link device accepts the first request frame, and update a mapping of the first traffic identifier from the first link to the at least two links, such that the traffic data is transmitted in parallel over the at least two links while the first link is in the first state.

According to some embodiments, a non-transitory computer-readable storage medium, storing computer code which, when executed by at least one processor, causes the at least one processor to at least: determine that a first link transmitting traffic data between a first multi-link device and a second multi-link device is in a first state, wherein the first state indicates that the first link has channel quality lower than a threshold or is congested; generate, in response to the first link being in the first state, a first request frame requesting the second multi-link device to map a first traffic identifier of the traffic data to at least two links between the first multi-link device and the second multi-link device; transmit the first request frame to the second multi-link device; receive a first response frame returned by the second multi-link device in response to the first request frame; and simultaneously transmit the traffic data over the at least two links based on the first response frame indicating that the second multi-link device accepts the first request frame, and update a mapping of the first traffic identifier from the first link to the at least two links, such that the traffic data is transmitted in parallel over the at least two links while the first link is in the first state.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 is a schematic diagram of a multi-link communication system according to some embodiments.

FIG. 2 is a schematic diagram of an application scenario for transmitting game data over a plurality of links according to some embodiments.

FIG. 3 is a schematic flowchart of a multi-link device communication method according to some embodiments.

FIG. 4 is a schematic interaction diagram of a multi-link device communication method according to some embodiments.

FIG. 5 is a schematic interaction diagram of a multi-link device communication method according to some embodiments.

FIG. 6 is a schematic flowchart of a multi-link selection policy method according to some embodiments.

FIG. 7 is a schematic format diagram of traffic-to-link mapping elements according to some embodiments.

FIG. 8 is a schematic interaction diagram of a multi-link device communication method according to some embodiments.

FIG. 9 is a schematic interaction diagram of a multi-link device communication method according to still some embodiments.

FIG. 10 is a schematic flowchart of a multi-link device communication method according to some embodiments.

FIG. 11 is a schematic structural diagram of a multi-link device according to some embodiments.

### DESCRIPTION OF EMBODIMENTS

To make a person skilled in the art better understand the technical solutions of the present disclosure, the following describes the technical solutions of some embodiments with reference to the accompanying drawings of some embodiments. Apparently, the described embodiments are some of some embodiments rather than all of the embodiments. All other embodiments obtained by a person of skill in the art for some embodiments without creative efforts fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In some embodiments, the term “module” or “unit” refers to a computer program with a predetermined function or a part of the computer program that works, together with other related parts, to implement a predetermined target, and may be completely or partially implemented by using software, hardware (for example, a processing circuit or a memory) or a combination thereof. Similarly, a processor (or a plurality of processors or memories) may be configured to implement one or more modules or units. In addition, each module or unit may be a part of an overall module or unit including a function of the module or unit.

In the specification, claims, and accompanying drawings of the present disclosure, the terms “first”, “second”, and the like are configured for distinguishing between different objects rather than describing a sequence. In addition, the terms “include”, “have”, and any variants thereof are intended to cover a non-exclusive inclusion. For example, a process, method, software, product, or device that includes a list of steps or units is not limited to the listed steps or units, but may further include steps or units not listed, or other steps or units inherent to such processes, methods, products, or devices.

The “embodiment” mentioned in the specification means that features, structures, or characteristics described with reference to the embodiment may be included in at least one embodiment of the present disclosure. The appearance of the term in different places throughout the specification does not necessarily mean the same embodiment, or an independent or alternative embodiment mutually exclusive with other embodiments. A person skilled in the art explicitly or implicitly understands that the embodiments described herein may be combined with other embodiments.

In some embodiments, “network” and “system” refer to the same concept, and a communication system is a communication network.

Some embodiments may be applied to a wireless local area network (WLAN). Protocol standards used by the WLAN are the IEEE 802.11 series. The WLAN may include a plurality of service sets (BSSs), and devices in a service set may include an access point station (AP STA, also referred to as an AP or an access point) and a non-access point station (Non-AP STA, also referred to as an STA or a station). In addition, each service set may include an access point and at least one station.

The access point may be an entity that provides network access, via a wireless medium, for a station connected to the access point. The access point may connect each wireless network client to an Ethernet network. The access point may be a network device of a wireless fidelity (Wi-Fi) chip. The access point may be a device that supports various IEEE 802.11 protocol standards. For example, the access point may be a device that supports IEEE 802.11ac, IEEE 802.11n, IEEE 802.11g, IEEE 802.11b, IEEE 802.11ax, IEEE 802.11be, or a next-generation WLAN protocol standard. The access point may include a centralized controller, a base station (BS), a base transceiver station (BTS), a station controller, a switch, in and the like. The access point may include an apparatus that provides a wireless communication function for a station, such as a chip system. The chip system may include a chip, and may further include other discrete devices such as a transceiver device. The access point may communicate with an Internet protocol (IP) network, for example, the Internet, a private IP network, or another data network.

The station may be a wireless communication chip, a wireless sensor, or a wireless communication terminal, for example, a user equipment (UE) that supports a Wi-Fi communication function, a remote terminal (remote UE), an access terminal, a user unit, a user station, a mobile device, a user terminal, a smart terminal, a wireless communication device, a user agent or a user apparatus/cellular phone, a cordless phone, a session initiation protocol (SIP) phone, a wireless local loop (WLL) station, a personal digital assistant (PDA), a handheld device, an in-vehicle device, a wearable device, or the like. This is not specifically limited. The station may include a non-AP extremely high throughput station (non-AP EHT STA), a non-AP high efficiency station (non-AP HE STA), or the like. The station may include an apparatus having a transceiver function, such as a chip system. The chip system may include a chip, and may further include other discrete devices such as a transceiver device.

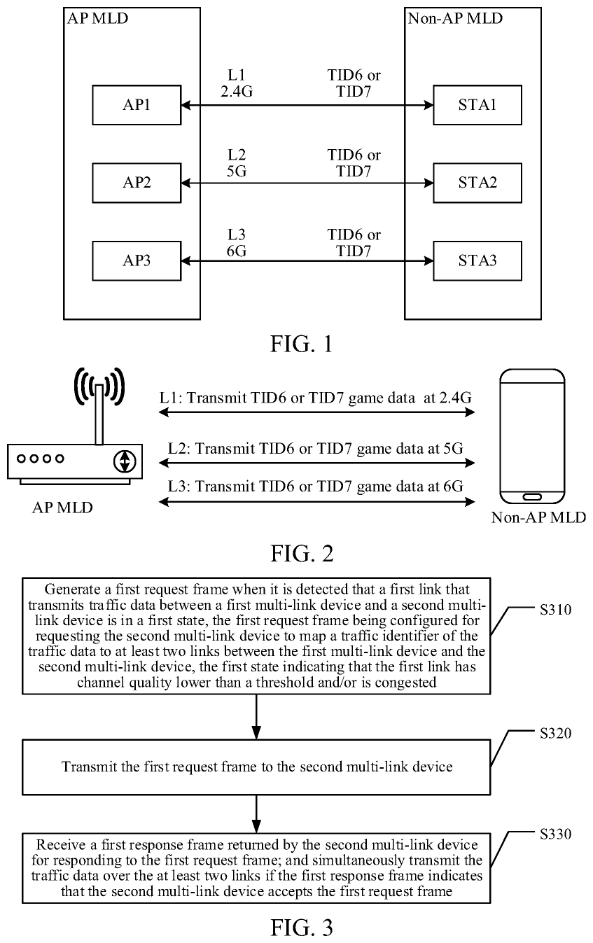

The following provides an exemplary description of a multi-link communication system according to some embodiments with reference to FIG. 1.

The IEEE 802.11be protocol standard introduces a multi-link mechanism. A Wi-Fi device that supports a multi-link operation (MLO) is a multi-link device (MLD). The multi-link device (MLD) can support data transmission over a plurality of links. The multi-link device may be an access point multi-link device (AP MLD) or a non-access point multi-link device (Non-AP MLD). The AP MLD may include a plurality of access points (APs, for example, as illustrated in FIG. 1, three APs, namely, AP1, AP2, and AP3, but the present disclosure is not limited thereto, and the AP MLD may include more or fewer APs). The Non-AP MLD may include a plurality of stations (STAs, for example, as illustrated in FIG. 1, three STAs, namely, STA1, STA2, and STA3, but the present disclosure is not limited thereto, and the Non-AP MLD may include more or fewer STAs). Different APs or STAs may operate at different carrier frequencies, for example, at carrier frequencies such as 2.4 GHz, 5 GHZ, and 6 GHz (respectively abbreviated as 2.4G, 5G, and 6G in FIG. 1) or different carrier frequencies within the same frequency band (for example, 5 GHZ). In some embodiments, the Non-AP MLD may be a user terminal that supports multi-link Wi-Fi 7 (that is, the technical standard IEEE 802.11be for the wireless local area network). The AP MLD may be a hotspot that supports multi-link Wi-Fi 7.

A plurality of (two or more) links may be established between the AP MLD and the Non-AP MLD (referred to as multi-link establishment or multi-link association), and data may be transmitted over the plurality of links.

For example, as shown in FIG. 1, it is assumed that a link L1 (abbreviated from Link1, that is, a link 1) is established between AP1 and STA1, a link L2 (abbreviated from Link2, that is, a link 2) is established between AP2 and STA2, a link L3 (abbreviated from Link3, that is, a link 3) is established between AP3 and STA3, and the like. Each link is uniquely identified by a link identifier (ID). Different links have different operating carrier frequencies. In FIG. 1, it is assumed that the operating carrier frequencies of L1, L2, and L3 are respectively 2.4G, 5G, and 6G, but the present disclosure is not limited thereto.

In some embodiments, a traffic identifier of traffic data may be established or updated to a high-priority traffic identifier, and the traffic identifier may be mapped to the plurality of links between the AP MLD and the Non-AP MLD. Traffic corresponding to the traffic data may be important traffic, high-throughput traffic, or low-latency traffic, such as game traffic, video traffic, audio traffic, or metaverse traffic. The following uses game traffic as an example for description, but the present disclosure is not limited thereto. The traffic identifier may be configured for uniquely identifying a type of traffic data, such as a voice service type, a video service type, a best-effort transmission type, or a background traffic type, to distinguish it from other types of traffic. A representation form of the traffic identifier is not limited in the present disclosure. For example, the traffic identifier may be represented by a traffic ID (TID). The TID is configured for identifying different types of traffic. Different types of traffic may be distinguished by setting a value of the TID, thereby providing different quality of service for different traffic. For example, the voice service is the most latency-sensitive, and is the highest-priority traffic. The video service has a priority lower than that of the voice service. A data traffic type of web page access is best-effort transmission, which has some latency requirements, but is not highly latency-sensitive. The background traffic is the least latency-sensitive traffic. The traffic identifier represented by a TID is used as an example below for description, but the present disclosure is not limited thereto.

For example, in FIG. 1, it is assumed that TID0 to TID7 (the present disclosure is not limited thereto, for example, TID0 to TID15 may also be used) may be used to represent different traffic identifiers, where traffic data corresponding to TID6 or TID7 has a higher priority than traffic data corresponding to TID0 to TID5. Assuming that the game traffic is low-latency traffic, a TID of traffic data of the game traffic may be set to or updated to TID6 or TID7, so that the traffic data of the game traffic has a higher priority than other traffic, thereby allowing the data of the game traffic to be preferentially transmitted, and reducing transmission latency of the game traffic. For the game traffic whose traffic identifier is mapped to TID6 or TID7, the traffic identifier TID6 or TID7 may be mapped to the plurality of links. For example, it is assumed in FIG. 1 that TID6 or TID7 of the game traffic is simultaneously mapped to Link1, Link2, and Link3, but the present disclosure is not limited thereto. Therefore, the game traffic data can be simultaneously transmitted over Link1, Link2, and Link3, thereby improving game reliability or reducing game latency in multi-link transmission under the IEEE protocol.

In some embodiments, the multi-link communication system shown in FIG. 1 may further include other multi-link devices, access points, or stations, excluding the AP MLD and the Non-AP MLD. This is not specifically limited.

In some embodiments, the multi-link communication system shown in FIG. 1 may further include other network entities such as a radio access network (RAN) device, a core network (CN) device, a network controller, and a mobility management entity. This is not specifically limited.

In some embodiments, the communication between the AP MLD and the Non-AP MLD in the multi-link communication system shown in FIG. 1 may be wireless communication or wired communication. This is not specifically limited.

Based on the embodiment in FIG. 1, assuming that TID6 or TID7 of the game traffic has been mapped to Link1 to Link3, as shown in FIG. 2, the TID6 or TID7 game data (that is, the traffic data) can be simultaneously transmitted between the AP MLD and the Non-AP MLD over Link1 whose operating carrier frequency is 2.4 GHz, Link2 whose operating carrier frequency is 5 GHZ, and Link3 whose operating carrier frequency is 6 GHz.

The multi-link communication system provided in some embodiments can simultaneously use a plurality of antennas and spectrum resources to perform traffic data transmission, so that the AP MLD and the Non-AP MLD can simultaneously communicate over a plurality of frequency bands, thereby improving network throughput and stability, reducing congestion and interference, and improving overall network performance. Multi-link transmission can also improve network reliability. Even if a frequency band or an antenna is subject to congestion or interference, the AP MLD and the Non-AP MLD can still communicate by combining other available links, thereby reducing a possibility of data loss.

The IEEE protocol introduces multi-link operation (MLO) characteristics. The AP and the STA that support the MLO can transmit data over one of the plurality of established links (for example, 2.4 GHZ, 5 GHZ, and 6 GHZ), or can simultaneously transmit data of the same traffic over the plurality of (two or more) communication links. The communication links may be mutually complementary, thereby reducing retransmission of data frames and improving reliability of data transmission. In this way, the plurality of links can transmit traffic data with the same TID. For example, for the game traffic, especially in an environment with weak network coverage, the transmission of the game data over the plurality of links can greatly improve transmission reliability and improve gaming experience. In some embodiments, by detecting traffic conditions and radio channel environment conditions of each of the plurality of established communication links, the Non-AP MLD and the AP MLD that support the MLO can transmit request frames (including a first request frame, and in some embodiments, also a second request frame) to each other through negotiation, to request to modify the TID mapping of the low-latency game traffic to the plurality of established communication links. This enables the plurality of communication links to transmit the game data, thereby improving reliability of data transmission, and improving gaming experience.

In some embodiments, the “simultaneously transmitting data of the same traffic” refers to parallel transmission of traffic data with the same traffic identifier, such as the same TID, over the plurality of established links between the Non-AP MLD and the AP MLD. Further, two modes may be used. One mode is multi-transmit single-receive (replication mode), in which an AP/STA end simultaneously transmits the same data with the same TID over the plurality of frequency bands/plurality of links to a receiving end (STA/AP), and the receiving end automatically selects data from the fastest frequency band/link. If a frequency band is subject to interference, the system receives data from another frequency band. This manner can improve stability of data transmission. The other mode is multi-transmit multi-receive (joint mode), in which one piece of data with the same TID is divided into a plurality of (for example, three) pieces of data and simultaneously transmitted over the plurality of (for example, three) frequency bands/plurality of (for example, three) links, and the receiving end combines the plurality of pieces of received data. The multi-transmit multi-receive mode can improve a data transmission rate.

For example, when the traffic data is the game data of the game traffic, it refers to “simultaneously transmitting game data of the same game traffic”, that is, parallel transmission of game data corresponding to the TID of the game traffic over the plurality of established links between the Non-AP MLD and the AP MLD. The same piece of game data may be replicated and transmitted in parallel over the plurality of links, to improve transmission reliability of the game data. For example, this mode may be used in scenarios with a weak channel environment. In some embodiments, the same piece of game data may be divided into a plurality of pieces of game data and transmitted in parallel over the plurality of links, to improve a transmission rate of the game data. For example, this mode may be used when the game traffic is congested.

In some embodiments, detecting the traffic conditions of the link refers to detecting whether data transmission of the traffic currently being transmitted (which may include, for example, the traffic) over at least one established link between the Non-AP MLD and the AP MLD is congested. In some embodiments, a congestion degree of the link may be determined by detecting congestion information of the link. Different congestion levels may be defined to represent different congestion degrees, or whether the link is in a congested state may be determined based on the congestion information. For example, a ping packet (which is a data packet for testing network connectivity) may be periodically transmitted over the detected link from a transmitting end (Non-AP MLD/AP MLD) to a receiving end (AP MLD/Non-AP MLD), to wait for receiving a signal returned by the receiving end, so that the transmitting end obtains a time for transmitting the data packet from the transmitting end to the receiving end and back. The time is referred to as a waiting time between the transmitting end and the receiving end, or may be referred to as a ping value. Based on the ping value, different congestion levels may be defined, or whether the link is in a congested state may be determined. For example, if the ping value on a link exceeds a specified duration, it may be determined that the link is congested; otherwise, it is determined that the link is uncongested. The manner of detecting the traffic conditions of the link in the present disclosure is not limited to the foregoing examples.

In some embodiments, detecting the radio channel environment conditions of the link refers to detecting channel quality information of at least one established link between the Non-AP MLD and the AP MLD, and determining, based on the channel quality information, whether the detected link is in a weak network environment. The channel quality information may be indicated by one or more metrics, such as a channel quality indicator (CQI), signal strength, a signal-to-noise ratio, a bit error rate, a transmission rate, and transmission latency of data in the channel. In the following embodiments, the radio channel environment conditions of the link are determined by detecting changes in relevant wireless communication metrics such as a received signal strength indication (RSSI), that is, the channel quality information includes the RSSI. When it is detected that an RSSI of a link is lower than a threshold (whose value may be set according to actual requirements, and is not limited in the present disclosure), it is determined that the link is in a weak network environment; otherwise, it is determined that the link is not in a weak network environment.

A communication method provided in an embodiment of FIG. 3 may be performed by a first multi-link device.

In some embodiments, the first multi-link device is an access point multi-link device (AP MLD, which may also be referred to as an AP multi-link device) or a non-access point multi-link device (Non-AP MLD, which may also be referred to as an STA multi-link device). The “multi-link” means that there are a plurality of communication links between an AP and an STA. Correspondingly, a second multi-link device mentioned below is a non-access point multi-link device (Non-AP MLD) or an access point multi-link device (AP MLD).

S310: Generate a first request frame when it is detected that a first link that transmits traffic data between the first multi-link device and the second multi-link device is in a first state, the first request frame being configured for requesting the second multi-link device to map a traffic identifier of the traffic data to at least two links between the first multi-link device and the second multi-link device, the first state indicating that the first link has channel quality lower than a threshold and/or is congested.

In some embodiments, at least one link has been established between the AP MLD and the Non-AP MLD, and the first link is determined from the at least one link for transmitting the traffic data. The traffic data may refer to data of any traffic, such as any important traffic, high-priority traffic, latency-sensitive traffic/low-latency traffic, or high-throughput traffic. The game traffic is used as an example below for description. The first link may include one link, or may include two or more links. An example in which the first link includes one link (which is represented as a link 1 or Link1 below) is used below for description, but the present disclosure is not limited thereto. The first link may be any one or any combination of the at least one established link between the AP MLD and the Non-AP MLD.

In some embodiments, the first state indicates that the first link has channel quality lower than the threshold, and/or that the traffic transmitted over the first link is congested.

In some embodiments, one link may transmit different traffic, and the method provided in some embodiments is applicable to any traffic, for example, game traffic with a latency requirement. When a plurality of pieces of traffic data are being transmitted over a link, if congestion is detected according to a congestion detection mechanism, the AP MLD may make a selection according to a policy. For example, the AP MLD may select two or three links to simultaneously transmit the traffic data, or switch the transmission to another link with better channel quality and in an uncongested state. The policy may be extended to other traffic and is not limited to the game traffic. In some embodiments, TIDs of other traffic are not mapped to TID6 or TID7, and TID6 or TID7 is dedicated to the game traffic with a low-latency requirement.

When the traffic data is transmitted over the first link between the AP MLD and the Non-AP MLD, the first multi-link device may detect channel quality information and/or congestion information of the first link, and determine, based on the channel quality information and/or the congestion information, whether the first link is in the first state. If the channel quality information indicates that the first link has channel quality lower than the threshold, that is, poor channel quality, and/or the congestion information indicates that the traffic transmitted over the first link is congested, or is in a congested state, it may be determined that the first link is in the first state. If the channel quality information indicates that the first link has channel quality equal to or higher than the threshold, that is, good channel quality, and the congestion information indicates that the traffic transmitted over the first link is not congested or is in an uncongested state, it may be determined that the first link is not in the first state, that is, neither in a weak network environment nor congested.

When the first multi-link device detects that the first link currently transmitting the traffic data has poor channel quality and/or the transmission of the traffic data is congested, the first multi-link device may generate a first request frame and transmit the first request frame to the second multi-link device, to request the second multi-link device to map the traffic identifier corresponding to the traffic data (for example, the TID of the traffic) to the at least two links between the AP MLD and the Non-AP MLD.

In some embodiments, the first request frame generated by the first multi-link device may carry a mapping relationship between the at least two links suggested or requested by the first multi-link device and the traffic identifier. In this case, the first multi-link device may determine the at least two links according to a multi-link selection policy.

The multi-link selection policy in some embodiments refers to a manner of selecting, when the traffic data needs to be transmitted over two or more links between the AP MLD and the Non-AP MLD, the two or more links from the plurality of established links between the AP MLD and the Non-AP MLD for transmitting the traffic data. The multi-link selection policy may be set according to actual requirements.

In some embodiments, before the generating a first request frame, the method may further include:
detecting a state of at least one second link between the first multi-link device and the second multi-link device if the first link is in the first state, the at least one second link being a link other than the first link among established links between the first multi-link device and the second multi-link device; and
selecting at least one target second link in a second state or a third state from the at least one second link, and determining the first link and the at least one target second link as the at least two links.

In some embodiments, the at least one target second link in the second state has channel quality lower than a threshold and/or is congested; and
the at least one target second link in the third state has channel quality higher than a threshold and is not congested.

For example, the multi-link selection policy may include: if the first link currently transmitting the traffic data is a link (for example, a link 1), and the first link has poor channel quality and/or the traffic transmission is congested, channel quality information and/or congestion information of the second link that is currently not transmitting the traffic data and that has been established between the AP MLD and the Non-AP MLD is detected. The second link may be one of the remaining links other than the first link among the plurality of established links between the AP MLD and the Non-AP MLD, where the remaining links include at least one link, or may be any one of the remaining links. That is, channel quality information and/or congestion information of each link other than the first link may be detected, to determine whether each link other than the first link is in the second state. If a second link has poor channel quality and/or traffic is congested, the second link may be selected as the target second link. If channel quality of a plurality of second links is poor and/or traffic is congested, a second link may be randomly selected from the plurality of second links as the target second link. In some embodiments, any link other than the first link is selected as the second link, and channel quality information and/or congestion information of the second link is detected, to determine whether the selected second link is in the second state. If the second link is in the second state, the second link is determined as the target second link; otherwise, a new second link continues to be selected from the remaining links, and channel quality information and/or congestion information of the new second link is detected, to determine whether the new second link is in the second state. This process is repeated until the target second link is determined from the remaining links. After the target second link is determined, the generated first request frame includes a mapping relationship between the traffic identifier and the first link as well as the target second link is included in, that is, the traffic identifier is mapped to the first link and the target second link, so that the traffic data can be simultaneously transmitted over the first link and the target second link. That is, when a first link currently transmitting traffic data has poor channel quality and/or traffic congestion, two links that have poor channel quality and/or have traffic congestion may be sequentially selected first to simultaneously transmit the traffic data, thereby improving reliability of traffic data transmission and reducing transmission latency.

Although in the foregoing example, the first link and the target second link are selected as the two links for simultaneously transmitting the traffic data, that is, the first link continues to be configured for transmitting the traffic data, the present disclosure is not limited thereto. For another example, if it is detected that a plurality of second links among the remaining links have poor channel quality and/or traffic congestion, any two of the plurality of second links may be selected as the target second links, and the first link does not continue to be configured for transmitting the traffic data. In this case, the first request frame includes a mapping relationship between the two target second links and the traffic identifier.

For another example, the multi-link selection policy may further include: if it is detected that one or more second links are in the third state, that is, one or more second links have good channel quality and no traffic congestion, any one of the one or more second links may be selected as the target second link. The first request frame is configured for requesting to switch the first link to the target second link, that is, to transmit the traffic data over the target second link, that is, the first request frame carries a mapping relationship between the traffic identifier and the target second link.

For another example, the multi-link selection policy may further include: if it is detected that a plurality of second links are in the third state, that is, a plurality of second links have good channel quality and no traffic congestion, any two of the plurality of second links may be selected as the target second links. The first request frame is configured for requesting to transmit the traffic data over the two target second links, that is, the first request frame carries a mapping relationship between the traffic identifier and the two target second links.

For another example, the multi-link selection policy may further include: if it is detected that at least one second link is in the third state, that is, the at least one second link has good channel quality and no traffic congestion, any one of the at least one second link may be selected as the target second link. The first request frame is configured for requesting to transmit the traffic data over the first link and the target second link, that is, the first request frame carries a mapping relationship between the traffic identifier and the first link as well as the target second link.

Because the first multi-link device and the second multi-link device learn in advance that the traffic identifier is mapped to the first link, when the first multi-link device requests, through the first request frame, to map the traffic identifier to the at least two links, the first request frame may carry only the mapping relationship between the traffic identifier and the target second link, that is, the mapping relationship between the traffic identifier and the first link is retained by default.

In some embodiments, different priorities may be bound to different links. Therefore, in the multi-link selection policy, the at least two links to which the traffic identifier is mapped may further be selected according to the binding relationship between the links and the priorities. For example, assuming that the first request frame requests to modify the traffic identifier from a low-priority first traffic identifier to a high-priority second traffic identifier, and the high-priority second traffic identifier has been bound to predetermined links, for example, the high-priority second traffic identifier has been bound to a link 1, a link 2, and a link 3, when receiving the first request frame, the second multi-link device may learn that the first multi-link device requests to map the traffic identifier to the link 1, the link 2, and the link 3. That is, it may be implicit that the first request frame requests to map the traffic identifier to the at least two links. That is, it is not necessarily required to indicate the mapping relationship between the traffic identifier and the at least two links in the first request frame. For example, links may be bound to priorities at the start of traffic. During the ongoing traffic, due to the mobility of the STA, channel quality may degrade or data traffic on a link may be congested. In this case, mapping between the TID of the traffic and the link may be negotiated in the manner provided in some embodiments.

In some embodiments, the first request frame includes information that indicates a change of the traffic identifier from the first traffic identifier to the second traffic identifier, where the second traffic identifier has a higher priority than the first traffic identifier.

In some embodiments, it is assumed that before the first request frame is generated, the traffic identifier is determined to be the first traffic identifier, for example, TID2, between the AP MLD and the Non-AP MLD, and TID2 is mapped to Link1. When the first multi-link device detects that Link1 has poor channel quality and/or traffic congestion, the first multi-link device may modify the traffic identifier into the higher-priority second traffic identifier, for example, TID6 or TID7. In this case, the first request frame may carry information of modifying the first traffic identifier into the higher-priority second traffic identifier, to request the second multi-link device to modify the first traffic identifier into the second traffic identifier, thereby reducing latency by increasing the priority of the traffic.

In some other embodiments, if before the first request frame is generated, the traffic identifier determined between the AP MLD and the Non-AP MLD has a high priority, for example, the traffic identifier is TID6 or TID7, the traffic identifier may not need to be modified.

In some embodiments, this may be implemented through quality of service (QoS). QoS is a network security mechanism, and is a technology for resolving issues such as network latency and congestion. When a network is overloaded or congested, QoS can ensure that important traffic is not delayed or discarded, and ensure efficient operation of the network. For example, for a game application, a network priority of the game application can be increased, thereby reducing latency and improving gaming experience.

In some embodiments, the first request frame is a traffic-to-link mapping request (TID-To-Link Mapping Request) frame. Correspondingly, a first response frame generated by the second multi-link device for responding to the first request frame may be a traffic-to-link mapping response (TID-To-Link Mapping Response) frame. However, the present disclosure is not limited thereto. In other embodiments, the first request frame and the first response frame may have other names.

In some embodiments, the traffic-to-link mapping request frame includes a traffic-to-link mapping element (TID-To-Link Mapping element). The mapping relationship between the traffic identifier and the at least two links may be carried in the TID-To-Link Mapping element.

In some embodiments, the traffic-to-link mapping element includes a traffic-to-link mapping control (TID-To-Link Mapping Control) field. In some embodiments, the traffic-to-link mapping control field includes a link mapping presence indicator subfield. A first value of the link mapping presence indicator subfield is configured for indicating that a traffic identifier-to-link mapping field (for example, Link Mapping Of TID6 or Link Mapping Of TID7) is present in the traffic-to-link mapping element.

In some embodiments, the traffic identifier-to-link mapping field is configured for indicating that the traffic identifier is mapped to the at least two links between the first multi-link device and the second multi-link device.

The indication information carried in the first request frame for requesting to map the traffic identifier to the at least two links is not limited to the foregoing example. Any manner capable of representing the indication information may be used, which may be explicit or implicit.

S320: Transmit the first request frame to the second multi-link device. The second multi-link device receives the first request frame transmitted by the first multi-link device.

S330: Receive the first response frame returned by the second multi-link device for responding to the first request frame; and simultaneously transmit the traffic data over the at least two links if the first response frame indicates that the second multi-link device accepts the first request frame.

After receiving the first request frame, the second multi-link device may determine, based on its own conditions, link conditions, the mapping relationship between the links and the traffic, network conditions, and the like, whether to accept or reject the first request frame, or modify the mapping relationship carried in the first request frame, to generate the first response frame returned to the first multi-link device and transmit the generated first response frame to the first multi-link device.

In some embodiments, the mapping relationship carried in the first request frame is a first mapping relationship.

When the first response frame includes a second mapping relationship determined by the second multi-link device, the mapping relationship between the traffic identifier in the first multi-link device and the first link is upgraded to the second mapping relationship if the first multi-link device accepts the second mapping relationship.

In some embodiments, when the first request frame does not carry the first mapping relationship, and the first response frame includes the second mapping relationship, the second mapping relationship is a mapping relationship between the traffic identifier and the at least two links that is determined by the second multi-link device based on the first request frame.

In some embodiments, when the first request frame carries the first mapping relationship, and the first response frame includes the second mapping relationship, the second mapping relationship is obtained by the second multi-link device modifying the first mapping relationship.

In some embodiments, the first multi-link device (for example, the station STA or the AP) may request only the second multi-link device (for example, the AP or the station STA) to map the traffic identifier to the at least two links, that is, the first request frame may not carry the at least two links requested or suggested by the first multi-link device. When the second multi-link device accepts the first request frame, the second multi-link device selects the at least two links mapped to the traffic identifier, and the second multi-link device returns, through the first response frame, the mapping relationship between the at least two links selected by the second multi-link device and the traffic identifier to the first multi-link device. If the second multi-link device rejects the first request frame, the first response frame returned by the second multi-link device may include indication information for rejecting the first request frame. In some embodiments, the first response frame may further include a reason for rejecting the first request frame.

In some other embodiments, the first request frame of the first multi-link device may carry the mapping relationship between the at least two links requested by the first multi-link device and the traffic identifier. When receiving the first request frame, the second multi-link device can only select to accept or reject the first request frame, but cannot propose a mapping relationship between at least two new links suggested or requested by the second multi-link device and the traffic identifier. If the second multi-link device accepts the first request frame, the first response frame returned to the first multi-link device includes indication information for accepting the first request frame. If the second multi-link device rejects the first request frame, the first response frame returned by the second multi-link device includes indication information for rejecting the first request frame. In some embodiments, the first response frame may further include a reason for rejecting the first request frame.

In some other embodiments, the first request frame of the first multi-link device may carry the mapping relationship between the at least two links suggested by the first multi-link device and the traffic identifier. When receiving the first request frame, the second multi-link device may select to accept or reject the first request frame, or modify the mapping relationship between the at least two links suggested in the first request frame and the traffic identifier. That is, the second multi-link device may further propose a mapping relationship between at least two new links suggested or requested by the second multi-link device and the traffic identifier. If the second multi-link device modifies the mapping relationship between the at least two links suggested in the first request frame and the traffic identifier, the second multi-link device may select the at least two new links mapped to the traffic identifier, and the second multi-link device returns the mapping relationship between the at least two new links selected by the second multi-link device and the traffic identifier to the first multi-link device through the first response frame. The at least two new links may be completely different from the at least two links in the first request frame, or partially the same and partially different. This is not limited in the present disclosure. If the second multi-link device accepts the first request frame, the first response frame returned to the first multi-link device includes indication information for accepting the first request frame. If the second multi-link device rejects the first request frame, the first response frame returned by the second multi-link device includes indication information for rejecting the first request frame. In some embodiments, the first response frame may further include a reason for rejecting the first request frame.

In some embodiments, the method provided in some embodiments may further include: updating the mapping relationship between the traffic identifier in the first multi-link device and the first link to the first mapping relationship based on the first response frame if the first response frame indicates that the second multi-link device accepts the first request frame.

When the second multi-link device accepts the first request frame, the second multi-link device may update the mapping relationship between the traffic identifier in the second multi-link device and the first link to the first mapping relationship while generating the first response frame.

The foregoing embodiments are described by using an example in which the first request frame carries the first mapping relationship between the traffic identifier and the first link as well as the target second link, and the second multi-link device accepts the first request frame. In other embodiments, if the second multi-link device modifies the first mapping relationship in the first request frame, to provide a new mapping relationship (the second mapping relationship), and the first multi-link device accepts the second mapping relationship carried in the first response frame, the first multi-link device and the second multi-link device separately upgrade the mapping relationship between the traffic identifier and the first link to the second mapping relationship. If the second multi-link device rejects the first request frame, or the first multi-link device rejects the new mapping relationship in the first response frame, the first multi-link device and the second multi-link device do not update the mapping relationship between the traffic identifier and the first link, that is, the first link is still used to transmit the traffic data.

In some embodiments, the method provided in some embodiments may further include: transmitting the traffic data in parallel over the first link and the target second link. When accepting the mapping relationship between the traffic identifier and the first link as well as the target second link that is carried in the first request frame, and returning the first response frame to the first multi-link device, the second multi-link device updates the mapping relationship between the traffic identifier of the second multi-link device and the link, that is, updates the mapping relationship between the traffic identifier and the first link to the mapping relationship between the traffic identifier and the first link as well as the target second link. The first multi-link device updates the mapping relationship between the traffic identifier of the first multi-link device and the link after receiving the first response frame. After the mapping relationship is updated, the first multi-link device and the second multi-link device may simultaneously transmit the traffic data over the first link and the target second link, that is, transmit traffic data with the same TID.

In some embodiments, the method provided in some embodiments may further include: generating a second request frame to request to map the traffic identifier to at least three links between the first multi-link device and the second multi-link device, if it is detected that the transmission of the traffic data over the at least two links (for example, the first link and the target second link) does not meet a traffic data transmission requirement; receiving a second response frame returned by the second multi-link device for responding to the second request frame; and simultaneously transmitting the traffic data over the at least three links if the second response frame indicates that the second multi-link device accepts the second request frame.

For example, when two links are used to simultaneously transmit traffic data with the same TID, it may be detected whether the simultaneous transmission of the traffic data over the two links meets the traffic data transmission requirement. The traffic data transmission requirement may be determined according to a requirement of the traffic, for example, a data transmission latency requirement or a transmission rate requirement of the traffic. If the traffic data transmission requirement is still not met when the two links are used, the first multi-link device may generate the second request frame to request the second multi-link device to map the traffic identifier to three or more links.

The second request frame may also be a TID-To-Link Mapping Request frame. Correspondingly, the second response frame may be a TID-To-Link Mapping Response frame. However, the present disclosure is not limited thereto. For the generation and transmission processes of the second request frame and the second response frame, refer to the foregoing processes of the first request frame and the first response frame.

The multi-link selection policy may further include: if it is detected that two links (for example, the first link (for example, the link 1) and the target second link (for example, the link 2)) currently transmitting traffic data still cannot meet the traffic data transmission requirement, channel quality information and/or congestion information of a third link that is not currently transmitting the traffic data and that has been established between the AP MLD and the Non-AP MLD is detected. The third link may be any one of the remaining links other than the first link and the target second link among the plurality of established links between the AP MLD and the Non-AP MLD. To determine whether the third link is in the second state, if the third link has poor channel quality and/or traffic congestion, a link may be selected from the third link as a target third link (for example, the link 3). After the target third link is determined, the generated second request frame includes the mapping relationship between the traffic identifier and the first link, the target second link, as well as the target third link, that is, the traffic identifier is mapped to the first link, the target second link, and the target third link, so that the traffic data can be simultaneously transmitted over the first link, the target second link, and the target third link. The target third link may be one or more links. This is not limited in the present disclosure.

For another example, if when the target second link is determined, the channel quality information and/or congestion information of the plurality of second links is detected, the plurality of second links has poor channel quality and/or traffic congestion, and only some of the second links are selected as the target second links, when the target third link is determined, a link may also be selected from the remaining second links as the target third link.

In some embodiments, by setting the foregoing multi-link selection policy, when a small number of links transmit traffic data and fail to meet the traffic data transmission requirement, links may be incrementally added to transmit the traffic data in parallel, thereby improving reliability of traffic data transmission, reducing transmission latency, further avoiding occupation of excessive links by the traffic, which causes resource waste, and avoiding affecting data transmission of other traffic. The first request frame and the second request frame are only used as examples for description, and actually do not limit the frequency and number of the request frames transmitted by the first multi-link device to the second multi-link device. After each update of the mapping relationship, the first multi-link device may detect whether a new mapping relationship can meet the traffic data transmission requirement. If the requirement is not met, a new request frame may be generated and transmitted to the second multi-link device, until an upper limit of the number of links between the first multi-link device and the second multi-link device is reached, that is, all established links between the first multi-link device and the second multi-link device have been used to transmit the traffic data.

In other embodiments, the following multi-link selection policy may also be used. When it is detected that the first link is in the first state, the first request frame requests to map the traffic identifier to all links between the first multi-link device and the second multi-link device.

In some embodiments, both the first multi-link device and the second multi-link device support negotiation of traffic-to-link mapping. That is, before the first multi-link device in some embodiments transmits the first request frame to the second multi-link device, the first multi-link device and the second multi-link device both can perform negotiation of TID-To-Link Mapping.

In the communication method provided in this implementation of the present disclosure, by detecting traffic conditions and radio channel environment conditions of each of the plurality of established communication links, the Non-AP MLD and the AP MLD that support the MLO can transmit the request frames (for example, the first request frame and the second request frame, which may be TID-To-Link Mapping Request frames) to each other through negotiation, to request to modify a low-latency traffic identifier (for example, a TID), to map the traffic identifier to two or more established communication links. This enables the two or more communication links to transmit traffic data with the same TID (for example, game data), thereby improving reliability of data transmission, and improving traffic experience.

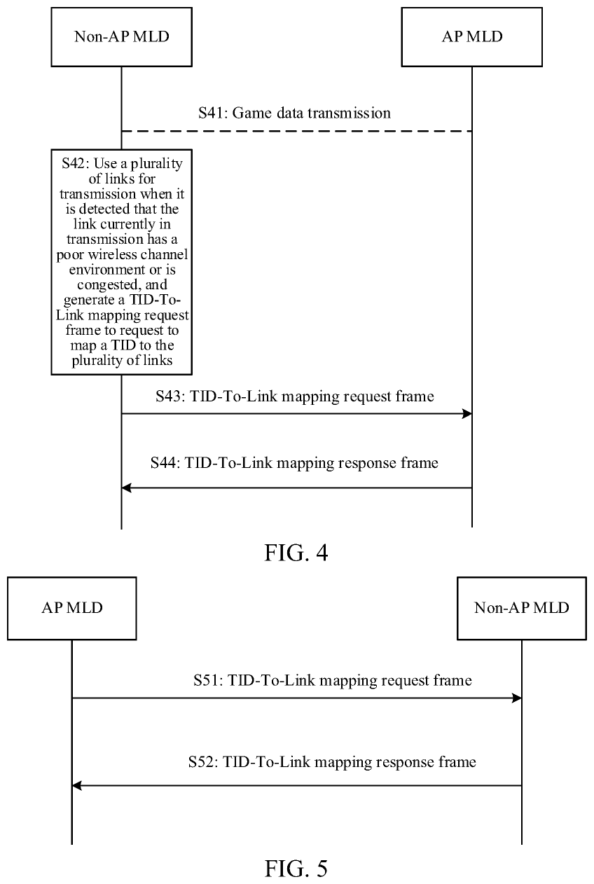

An embodiment of FIG. 4 is described by using game traffic as an example, where the first multi-link device is a Non-AP MLD, and the first request frame is a TID-To-Link Mapping Request frame. As shown in FIG. 4, the method provided in some embodiments may include the following operations.

S41: The Non-AP MLD and the AP MLD transmit game data over a link (for example, a link 1).

S42: The Non-AP MLD uses a plurality of links for transmission when it is detected that the link currently in transmission (for example, the link 1) has a poor radio channel environment or is congested, and generates a TID-To-Link Mapping Request frame to request to map a TID of the game traffic to the plurality of links.

S43: The Non-AP MLD transmits the TID-To-Link Mapping Request frame to the AP MLD.

Due to changes in the wireless environment, the Non-AP MLD currently performing transmission of game data with the AP MLD may be affected, and the Non-AP MLD detects in real time changes in relevant wireless communication metrics of the link (such as an RSSI) or congestion conditions of the link, and then selects to map the game TID to two or more links. The Non-AP MLD generates a TID-To-Link Mapping Request frame, and transmits the TID-To-Link Mapping Request frame to the AP MLD.

S44: The AP MLD transmits a TID-To-Link Mapping Response frame to the Non-AP MLD.

After receiving the TID-To-Link Mapping Request frame, the AP MLD generates a TID-To-Link Mapping Response frame, and replies to the Non-AP MLD with the TID-To-Link Mapping Response frame, to notify the transmitting end (that is, the Non-AP MLD) to receive or reject the request. In some embodiments, in addition to acceptance or rejection, the AP MLD may modify the mapping relationship between the TID requested by the TID-To-Link Mapping Request frame and the link, then add a modified mapping relationship between the TID and the link to the TID-To-Link Mapping Response frame, and return the TID-To-Link Mapping Response frame to the Non-AP MLD.

In some other embodiments, the AP MLD may also detect the changes in the wireless environment and the congestion conditions of the traffic currently being transmitted (detect congestion conditions of links currently transmitting data), then select to map the game TID to two or more links, and transmit the TID-To-Link Mapping Request frame to the Non-AP MLD. The Non-AP MLD receives the TID-To-Link Mapping Request frame, and transmits the TID-To-Link Mapping Response frame to the AP MLD, as shown in FIG. 5.

S51: The AP MLD detects that the link currently transmitting data has a poor radio channel environment or is congested, transmits the data over the plurality of links, generates a TID-To-Link Mapping Request frame to request to map the game TID to the plurality of links, and transmits the generated TID-To-Link Mapping Request frame to the Non-AP MLD.

S52: The Non-AP MLD transmits the TID-To-Link Mapping Response frame to the AP MLD.

After receiving the TID-To-Link Mapping Request frame, the Non-AP MLD replies to the AP MLD with the TID-To-Link Mapping Response frame, to notify the transmitting end (that is, the AP MLD) to accept or reject the request. In some embodiments, in addition to acceptance or rejection, the Non-AP MLD may modify the mapping relationship between the TID requested by the TID-To-Link Mapping Request frame and the link, then add a modified mapping relationship between the TID and the link to the TID-To-Link Mapping Response frame, and return the TID-To-Link Mapping Response frame to the AP MLD.

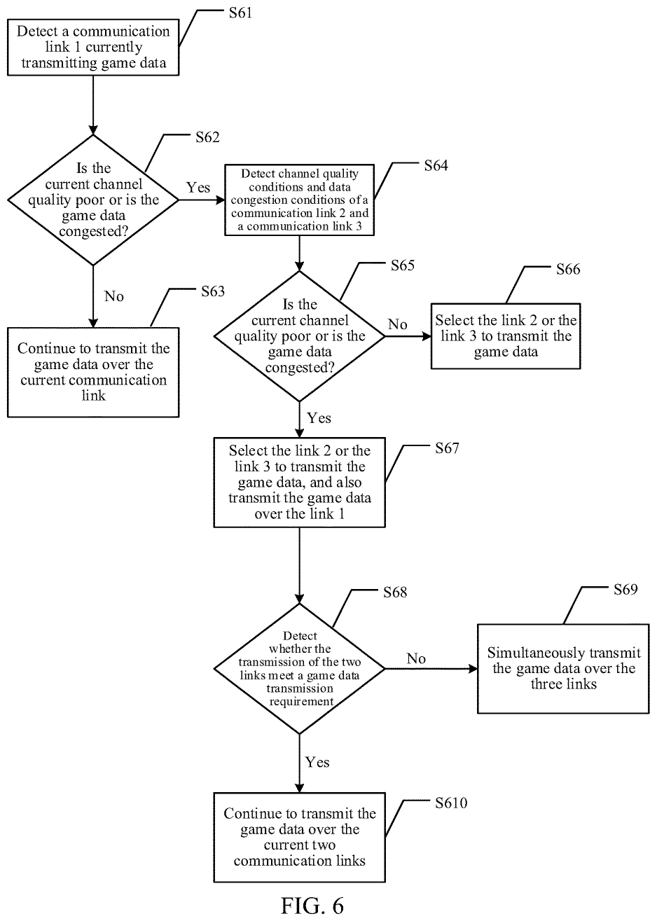

FIG. 6 is a schematic flowchart of a multi-link selection policy method according to some embodiments. The multi-link selection policy shown in FIG. 6 is merely an example for description, and the present disclosure is not limited thereto.

S61: Detect a communication link 1 currently transmitting game data.

Assuming that a link 1, a link 2, and a link 3 have been established between an AP MLD and a Non-AP MLD, game traffic is used as an example, where it is initially determined to transmit the game data over the link 1.

S62: Determine whether the current channel quality of the link 1 is poor or whether the game data is congested. If not, perform S63. If yes, perform S64.

S63: If the current channel quality of the link 1 is good, and the game data is not congested, continue to transmit the game data over the current communication link (for example, the link 1).

In some embodiments, the process may return to S61 to continue to detect the communication link 1 currently transmitting game data, to repeatedly perform the foregoing S61 to S63.

S64: If the current channel quality of the link 1 is poor or the game data is congested, detect channel quality and data congestion conditions of a communication link 2 and a communication link 3.

S65: Determine whether the current channel quality of the link 2 and the link 3 is poor or whether the game data is congested. If not, perform S66. If yes, perform S67.

S66: If the current channel quality of the link 2 and the link 3 is good and the game data is not congested, select the link 2 or the link 3 to transmit the game data, that is, the link 1 is switched to the link 2 or the link 3, and the link 1 is no longer configured for transmitting the game data.

S67: If the current channel quality of the link 2 or the link 3 is poor or the game data is congested, select the link 2 or the link 3 to transmit the game data, and also transmit the game data over the link 1. Then, perform S68.

S68: Detect whether the transmission over the two links meets a game data transmission requirement. If not, perform S69. If yes, perform S610.

S69: If the game data transmission requirement is not met, simultaneously transmit the game data over the three links.

S610: If the game data transmission requirement is met, continue to transmit the game data over the current two communication links.

In some embodiments, the AP MLD or the Non-AP MLD detects in real time the communication link currently transmitting game data, which is assumed to be the link 1. When the link 1 has poor channel quality or the traffic over the link 1 is congested, channel quality and traffic congestion conditions of other links, defined as the link 2 and the link 3, are simultaneously detected. The link 2 or the link 3 may be selected to transmit the same game data as the link 1. Then, it is detected whether the transmission over the two links meets the game data transmission requirement. If the requirement is met, the game data continues to be transmitted over the two links. If the requirement is not met, the same game data is simultaneously transmitted over the link 1, the link 2, and the link 3.

In some embodiments, two management frames in the IEEE series of protocols: the TID-To-Link Mapping Request frame and the TID-To-Link Mapping Response frame, may be used to implement the foregoing negotiation process.

The TID-To-Link Mapping Request frame is transmitted by the Non-AP MLD to the AP MLD, or transmitted by the AP MLD to the Non-AP MLD, to negotiate modification of the mapping of the TID to the plurality of communication links. A format of the TID-To-Link Mapping Request frame may be shown in the following Table 1:

TABLE 1
TID-To-Link Mapping Request frame format

| Order | Information |
|---|---|
| 1 | Category |
| 2 | Protected EHT Action |
| 3 | Dialog Token |
| 4 | TID-To-Link Mapping |

The TID-To-Link Mapping Response frame may be a response from the AP MLD or the Non-AP MLD to the received TID-To-Link Mapping Request frame. A format of the TID-To-Link Mapping Response frame may be shown in the following Table 2:

TABLE 2
TID-To-Link Mapping Response frame format

| Order | Information |
|---|---|
| 1 | Category |
| 2 | Protected EHT Action |
| 3 | Dialog Token |
| 4 | Status Code |
| 5 | TID-To-Link Mapping |

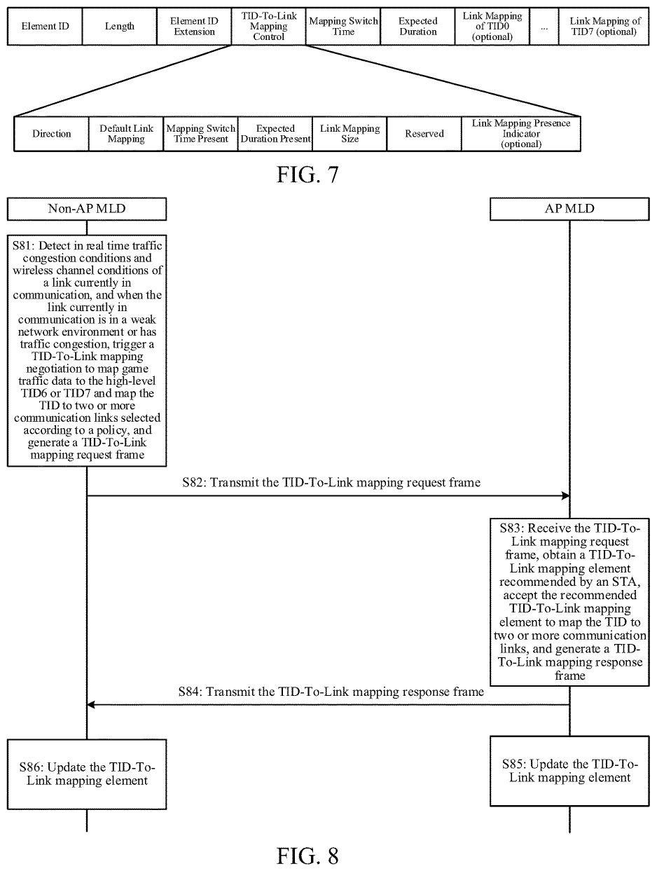

The TID-To-Link Mapping Request frame and the TID-To-Link Mapping Response frame each include a TID-To-Link Mapping (traffic-to-link mapping element). A data format of the TID-To-Link Mapping element is shown in FIG. 7.

As shown in FIG. 7, the TID-To-Link Mapping element includes an Element ID field, a Length field, an Element ID Extension field, a TID-To-Link Mapping Control field, a Mapping Switch Time field, an Expected Duration field, and the like. The TID-to-Link Mapping Control field includes a Direction field, a Default Link Mapping bit, a Mapping Switch Time Present field, an Expected Duration Present field, a Link Mapping Size field, and a Reserved field. In an embodiment, the TID-to-Link Mapping Control field further includes a Link Mapping Presence Indicator subfield.

When the Direction field is set to a first value (for example, 0), it indicates uplink; when the Direction field is set to a second value (for example, 1), it indicates downlink; when the Direction field set to a third value (for example, 2), it indicates uplink and downlink; and when the Direction field set to a fourth value (for example, 3), it is a reserved value.

The Default Link Mapping bit is configured for indicating whether all TIDs are mapped to all links. When the Default Link Mapping bit is set to a first value (for example, 1), it indicates that all TIDs are mapped to all links. It is assumed that there are three communication links between the Non-AP MLD and the AP MLD, which are Link1, Link2, and Link3. When the Default Link Mapping bit is set to 1, TIDs 0 to 7 are mapped to Link1, TIDs 0 to 7 are mapped to Link2, and TIDs 0 to 7 are mapped to Link3.

The Link Mapping Presence Indicator subfield indicates whether a “Link Mapping Of TIDn” field is present in the TID-To-Link Mapping element. If a value at position n of the Link Mapping Presence Indicator subfield is a first value (for example, 1), it indicates that the Link Mapping Of TIDn field is present in the TID-To-Link Mapping element. Otherwise, the Link Mapping Of TIDn field is not present in the TID-To-Link Mapping element.

The Link Mapping Size field is configured for indicating a size of the Link Mapping Of TIDn field, which may be 0, 1, or 2 bytes.

The Link Mapping of TID0 field may be configured for indicating which links TID0 is mapped to. For example, the field may carry a bitmap, and each bit in the bitmap may correspond to one link. If a value of a bit is 1, it indicates that TID0 is mapped to a link corresponding to the bit. For another example, if a value of a bit is 0, it indicates that TID0 is not mapped to a link corresponding to the bit. Exemplarily, a length of the bitmap may be equal to the maximum number of links that can be associated between the first multi-link device and the second multi-link device. In some embodiments, a length of the bitmap may be a fixed value, for example, 16 bits. In some embodiments, a length of the bitmap may be equal to the number of established associated links between the first multi-link device and the second multi-link device, and the like. The manner of setting the length of the bitmap is not limited in some embodiments. For the description of the Link Mapping fields of other TIDS, refer to the Link Mapping of TID0 field. Details are not described herein again. TID0 to TID7 shown in some embodiments are merely examples. With the evolution of the standard, more traffic types such as TID0 to TID15 may be introduced subsequently. Therefore, the number of the Link Mapping of TID fields in the TID-To-Link Mapping element is not limited in some embodiments. Exemplarily, the number of the Link Mapping of TID fields in the TID-To-Link Mapping element may be the same as the number of TID types. For example, when the TIDs are extended from TID0 to TID7 to TID0 to TID15, the number of the Link Mapping of TID fields may be equal to 16.

In some embodiments, assuming that the traffic identifier of the game traffic isTID6 or TID7, and it is requested to map the game traffic to at least two links, for example, it is requested to map TID6 or TID7 to Link1 and Link2, Link Mapping Of TID6 and Link Mapping Of TID7 are present in the TID-To-Link Mapping element. Link Mapping Of TID6 corresponds to a 3-bit bitmap respectively representing Link1 to Link 3, and a value of the bitmap is [1 1 0]. Link Mapping Of TID7 corresponds to a 3-bit bitmap, and a value of the bitmap is [1 1 0].

The Mapping Switch Time field may be configured for indicating an effective start time or an effective time of mapping between a traffic identifier and a link, or may be configured for indicating an effective start time or an effective time of a mapping relationship between a traffic identifier and a link, or may be configured for indicating a time at which a mapping relationship between a traffic identifier and a link is established. The Mapping Switch Time Present field is configured for indicating whether the Mapping Switch Time field is present in the TID-To-Link Mapping element. The Expected Duration field may be configured for indicating an expected end time of a mapping relationship between a traffic identifier and a link, or may be configured for indicating an expected end time of mapping between a traffic identifier and a link. The Expected Duration Present field is configured for indicating whether the Expected Duration field is present in the TID-To-Link Mapping element.

In some embodiments, after the plurality of links between the AP MLD and the Non-AP MLD are successfully established, the Non-AP MLD can detect radio channel conditions of the communication links currently transmitting game data and congestion conditions of the ongoing traffic. If the radio channel quality is lower than a set threshold (the channel quality is poor) or the ongoing traffic is approaching congestion or already in a congested state, the Non-AP MLD selects, according to the multi-link selection policy, the plurality of links to which the traffic identifier is mapped. The STA MLD (that is, the Non-AP MLD) actively transmits a TID-To-Link Mapping negotiation message (for example, the TID-To-Link Mapping request frame) to the AP MLD, suggesting that the low-latency game data TID be mapped to the high-level TID6 or TID7 and mapped to two or more links currently in communication. In this way, the low-latency game data can be transmitted over the plurality of links, thereby improving reliability of the game data and gaming experience of the user.

In some embodiments, the AP MLD can perform multi-link mapping during the multi-link establishment. Therefore, the first request frame may also be an association request frame or a reassociation request frame, and correspondingly, the first response frame may be an association response frame or a reassociation response frame. During the ongoing traffic, the Non-AP MLD/AP MLD can transmit the mapping between the TID and the links that is expected to be modified to the AP MLD/Non-AP MLD by detecting relevant metrics.

As shown in FIG. 8, the method provided in some embodiments may include the following operations.

S81: The Non-AP MLD detects in real time traffic congestion conditions and radio channel conditions of a link currently in communication (for example, the link 1), and when the link currently in communication is in a weak network environment or has traffic congestion, triggers a TID-To-Link mapping negotiation to map game traffic data to the high-level TID6 or TID7 and map TID6 or TID7 to two or more communication links selected according to the policy, and generates a TID-To-Link mapping request frame.

S82: The Non-AP MLD transmits the TID-To-Link mapping request frame to the AP MLD.

S83: The AP MLD receives the TID-To-Link mapping request frame, obtains a TID-To-Link mapping element recommended by an STA in the Non-AP MLD, accepts the recommended TID-To-Link mapping element, accepts to map TID6 or TID7 to two or more communication links, and generates a TID-To-Link mapping response frame.

In some embodiments, the AP MLD may also select to reject or modify the TID-To-Link mapping element recommended by the STA in the Non-AP MLD.

S84: The AP MLD transmits the TID-To-Link mapping response frame to the Non-AP MLD.

S85: The AP MLD updates the TID-To-Link mapping element.

S86: The Non-AP MLD updates the TID-To-Link mapping element.

In some embodiments, the AP MLD and the Non-AP MLD both support the TID-To-Link Mapping negotiation. The dot11MultiLinkActivated (multi-link activation field) and the dot11TIDToLinkMappingActivated (traffic-to-link mapping activation field) carried in the association request frame or the reassociation request frame, and the association response frame or the reassociation response frame that are transmitted between the AP MLD and the Non-AP MLD are set to a first value (for example, true). In addition, the TID-To-Link Mapping Negotiation Support in the Capabilities and Operations of the Multi-Link element field is set to a non-zero value (for example, 3, but the present disclosure is not limited thereto). The foregoing indication information is used to indicate that the AP MLD and the Non-AP MLD both support the traffic-to-link mapping function, which for example, may be shown in the following Table 3:

TABLE 3

| | | | | | |
|---|---|---|---|---|---|
| Maximum | SRS | TID-To-Link | Frequency | AAR | Reserved |
| Number Of | Support | Mapping | Separation | Support | |
| Simul- | | Negotiation | For STR/AP | | |
| taneous | | Support | MLD Type | | |
| Links | | | Indication | | |

Maximum Number Of Simultaneous Links is configured for indicating the maximum number of links over which traffic data with the same TID can be transmitted in parallel. Single response scheduling (SRS) is a control frame. SRS Support may be configured for indicating whether to accept the association request frame or the reassociation request frame carrying SRS Control. An AP assistance request (AAR) is also a control frame. AAR Support may be configured for indicating whether to accept the association request frame or the reassociation request frame carrying AAR Control. Simultaneous transmit and receive (STR) refers to an interval between links in a plurality of links over which transmission and reception occur simultaneously. Frequency Separation For STR/AP MLD Type Indication refers to frequency separation indicated by an STR/AP MLD type.

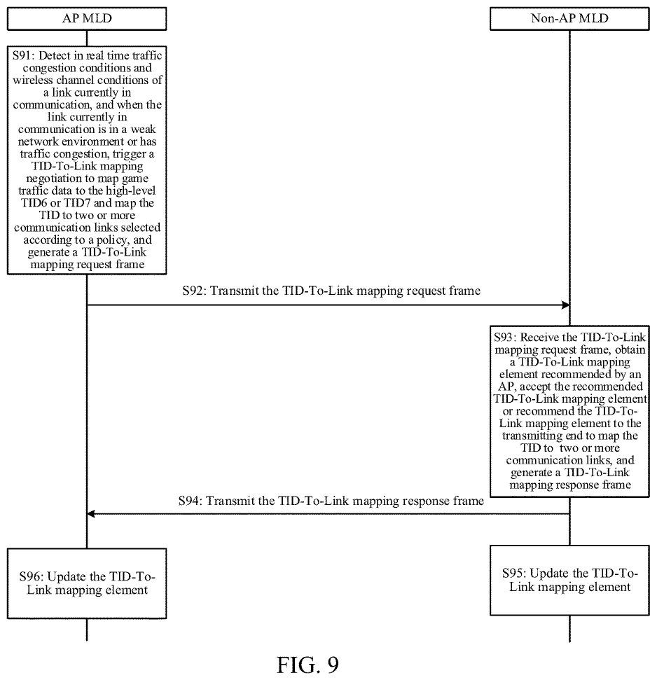

When the AP MLD and the Non-AP MLD both support the TID-to-Link mapping negotiation, the mapping of the TID of the traffic to two or more communication links can be modified through the negotiation. In some other embodiments, the AP MLD may also negotiate with the Non-AP MLD to modify the mapping of the TID to the communication links. As shown in FIG. 9, the following operations may be included.

S91: The AP MLD detects in real time congestion conditions and network coverage conditions of the communication link currently transmitting game traffic, and when the congestion exceeds a set threshold or the link is in a weak network environment, triggers a TID-To-Link mapping negotiation to map game traffic data to the high-level TID6 or TID7 and map TID6 or TID7 to two or more communication links selected according to a policy, and generates a TID-To-Link mapping request frame.

S92: The AP MLD transmits the TID-To-Link mapping request frame to the Non-AP MLD.

S93: The Non-AP MLD receives the TID-To-Link mapping request frame, obtains a TID-To-Link mapping element recommended by an AP in the AP MLD, accepts the TID-To-Link mapping element recommended by the AP, or recommends the TID-To-Link mapping element to the transmitting end (the AP MLD), and generates a TID-To-Link mapping response frame.

S94: The Non-AP MLD transmits the TID-To-Link mapping response frame to the AP MLD.

S95: The Non-AP MLD updates the TID-To-Link mapping element.

S96: The AP MLD updates the TID-To-Link mapping element.

Some embodiments relates to a Wi-Fi wireless network, in which a wireless terminal (the Non-AP MLD) performs low-latency traffic, such as game traffic. In scenarios of weak network coverage or a traffic congestion scenario, an AP or an STA that supports a plurality of Links and also supports TID-To-Link Mapping can independently detect whether links currently communicating with the AP or STA have weak network coverage or traffic congestion, to determine whether to trigger to transmit to the receiving end a request frame of modifying the mapping relationship between the TID of the traffic and the links, and mapping the TID of the traffic to two or more links. After receiving the request frame, the receiving end correspondingly transmits a response frame of the mapping of the TID of the traffic to two or more links, to notify the transmitting end whether to accept or reject the request frame. If the receiving end accepts the request frame, both ends update the rule of mapping the TID to two or more links. Through the foregoing improvements, especially during the low-latency traffic transmission, transmission of the traffic data over the two or more links can be adaptively optimized based on the network coverage conditions and the traffic congestion conditions. Particularly, in scenarios with weak wireless network coverage or congested ongoing traffic, reliability of the traffic data transmission can be improved, and the user's perception can be improved. When the traffic is a game, reliability of the game can be improved in multi-link transmission under the IEEE protocol.

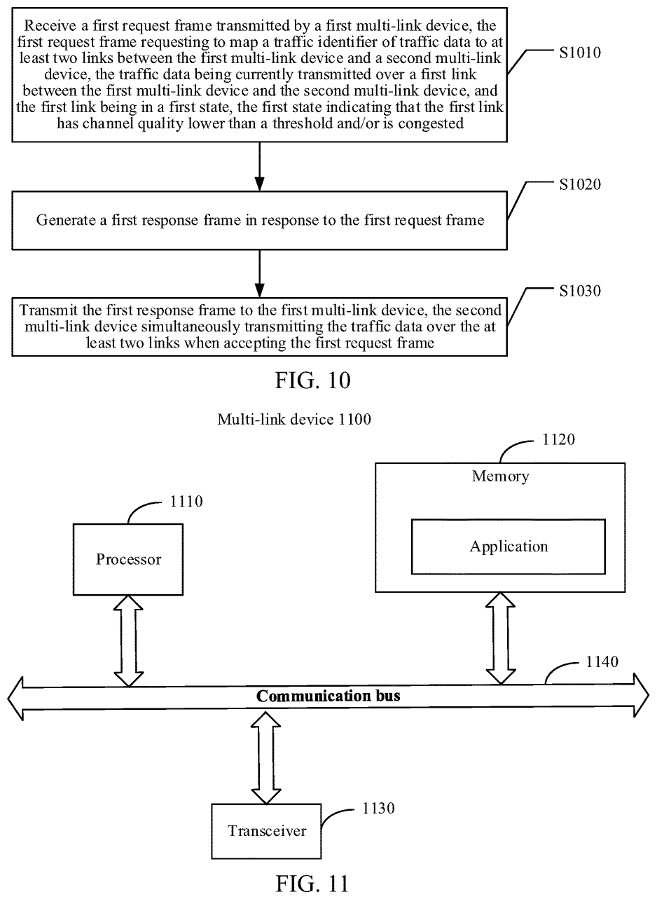

A method provided in an embodiment of FIG. 10 may be performed by a second multi-link device. As shown in FIG. 10, the method provided in some embodiments may include the following operations.

S1010: Receive a first request frame transmitted by a first multi-link device, the first request frame requesting to map a traffic identifier of traffic data to at least two links between the first multi-link device and the second multi-link device, the traffic data being currently transmitted over a first link between the first multi-link device and the second multi-link device, and the first link being in a first state, the first state indicating that the first link has channel quality lower than a threshold and/or is congested.

S1020: Generate a first response frame in response to the first request frame.

S1030: Transmit the first response frame to the first multi-link device, the second multi-link device simultaneously transmitting the traffic data over the at least two links when accepting the first request frame.

For other content of the embodiment of FIG. 10, refer to the foregoing other embodiments.

FIG. 11 is a schematic structural diagram of a multi-link device 1100 according to some embodiments. The multi-link device may be a Non-AP MLD or an AP MLD. The multi-link device 1100 shown in FIG. 11 includes a processor 1110. The processor 1110 may invoke and execute a computer program from a memory, to implement the method in some embodiments.

In some embodiments, as shown in FIG. 11, the multi-link device 1100 may further include a memory 1120. The processor 1110 may invoke and execute a computer program from the memory 1120, to implement the method in some embodiments.

The memory 1120 may be a separate device independent of the processor 1110, or may be integrated into the processor 1110.

In some embodiments, as shown in FIG. 11, the multi-link device 1100 may further include a transceiver 1130, and the processor 1110 may control the transceiver 1130 to communicate with other devices, specifically, transmit information or data to other devices, or receive information or data transmitted by other devices.

The transceiver 1130 may include a transmitter and a receiver. The transceiver 1130 may further include one or more antennas.

In some embodiments, the processor 1110, the memory 1120, and the transceiver 1130 may implement bidirectional communication with each other through a communication bus 1140.

The processor in some embodiments may be an integrated circuit chip, which has a signal processing capability. During implementation, the operations in the foregoing method embodiments may be completed by an integrated logic circuit of hardware in the processor or by instructions in a form of software.

The processor may be a general-purpose processor, a digital signal processor (DSP), an application-integrated circuit (ASIC), a field programmable gate array (FPGA) or another programmable logic device, a discrete gate or transistor logic device, or a discrete hardware component; and may implement or perform the methods, the operations, and logic block diagrams that are disclosed in some embodiments. The general-purpose processor may be a microprocessor or the processor may be any conventional processor. The operations of the methods disclosed with reference to some embodiments may be directly performed and completed by using a hardware decoding processor, or may be performed and completed by using a combination of hardware and software modules in a decoding processor. The software module may be located in a mature storage medium in the art, such as a random access memory, a flash memory, a read-only memory, a programmable read-only memory, an electrically erasable programmable memory, and a register. The storage medium is located in a memory. The processor reads information in the memory and performs the operations of the foregoing methods based on hardware of the processor.

The memory in some embodiments may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. Through illustrative but not restrictive description, RAMs in many forms are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memories of the system and method described herein are intended to include, but are not limited to, these memories and any other suitable types of memories. The foregoing memories are exemplary but not restrictive.

Some embodiments further provides a computer-readable storage medium, configured to store a computer program. In some embodiments, the computer-readable storage medium may be used in the Non-AP MLD or the AP MLD in some embodiments, and the computer program causes the Non-AP MLD or the AP MLD to execute the corresponding processes implemented by the Non-AP MLD or the AP MLD in the methods of some embodiments.

Some embodiments further provides a computer program product, including computer program instructions. In some embodiments, the computer program product may be used in the Non-AP MLD or the AP MLD in some embodiments, and the computer program instructions cause the Non-AP MLD or the AP MLD to execute the corresponding processes implemented by the Non-AP MLD or the AP MLD in the methods of some embodiments.

Some embodiments further provides a computer program. In some embodiments, the computer program may be used in the Non-AP MLD or the AP MLD in some embodiments. When the computer program is run on the Non-AP MLD or the AP MLD, the Non-AP MLD or the AP MLD is caused to execute the corresponding processes implemented by the Non-AP MLD or the AP MLD in the methods of some embodiments.

The network architecture and the traffic scenario described in some embodiments are intended to describe the technical solutions in some embodiments more clearly, and do not constitute a limitation on the technical solutions provided in some embodiments. A person of skill in the art may learn that with the evolution of the network architecture and the emergence of new traffic scenarios, the technical solutions provided in some embodiments are also applicable to similar technical problems.

What is claimed is:

1. A multi-link device communication method, performed by a first multi-link device, the method comprising:
determining that a first link transmitting traffic data between the first multi-link device and a second multi-link device is in a first state, wherein the first state indicates that the first link has channel quality lower than a threshold or is congested;
generating, in response to the first link being in the first state, a first request frame requesting the second multi-link device to map a first traffic identifier of the traffic data to at least two links between the first multi-link device and the second multi-link device;
transmitting the first request frame to the second multi-link device;
receiving a first response frame returned by the second multi-link device in response to the first request frame; and
simultaneously transmitting the traffic data over the at least two links based on the first response frame indicating that the second multi-link device accepts the first request frame, and updating a mapping of the first traffic identifier from the first link to the at least two links, such that the traffic data is transmitted in parallel over the at least two links while the first link is in the first state.

2. The method according to claim 1, wherein the first request frame comprises the first traffic identifier and a first mapping relationship that maps the first traffic identifier to the at least two links.

3. The method according to claim 1, further comprising:
in response to the first link being in the first state, detecting a state of at least one second link, wherein the at least one second link is an established link, other than the first link, between the first multi-link device and the second multi-link device; and
selecting, from the at least one second link, at least one target second link that is in a second state or a third state; and
determining the first link and the at least one target second link collectively as the at least two links.

4. The method according to claim 3, wherein the second state is a state in which the at least one target second link has channel quality lower than the threshold or is congested; and
wherein the third state is a state in which the at least one target second link has channel quality higher than the threshold and is not congested.

5. The method according to claim 1, further comprising:
based on detecting that the transmission of the traffic data over the at least two links does not meet a transmission requirement, generating a second request frame requesting the second multi-link device to map the first traffic identifier to at least three links between the first multi-link device and the second multi-link device;
receiving a second response frame returned by the second multi-link device in response to the second request frame; and
simultaneously transmitting the traffic data over the at least three links based on the second response frame indicating that the second multi-link device accepts the second request frame, and updating the mapping of the first traffic identifier from the at least two links to the at least three links.

6. The method according to claim 2, further comprising:
based on the first response frame indicating that the second multi-link device accepts the first request frame, updating, at the first multi-link device, a mapping relationship between the first traffic identifier and the first link to be the first mapping relationship; and
based on the first response frame indicating that the second multi-link device rejects the first request frame, continuing to transmit the traffic data over the first link.

7. The method according to claim 2, further comprising:
based on the first response frame comprising a second mapping relationship determined by the second multi-link device and the first multi-link device accepting the second mapping relationship, updating, at the first multi-link device, a mapping relationship between the first traffic identifier and the first link to be the second mapping relationship,
wherein the second mapping relationship is either a mapping relationship that maps the first traffic identifier to the at least two links and is determined by the second multi-link device based on the first request frame, or a mapping relationship obtained by the second multi-link device modifying the first mapping relationship.

8. The method according to claim 1, wherein the first request frame comprises information indicating a change of the first traffic identifier to a second traffic identifier, wherein the second traffic identifier has a higher priority than the first traffic identifier.

9. The method according to claim 8, further comprising:
based on a binding relationship between links and priorities, determining the links bound to the second traffic identifier to be the at least two links.

10. The method according to claim 1, wherein the first request frame is a traffic-to-link mapping request frame,
wherein the traffic-to-link mapping request frame comprises a traffic-to-link mapping element,
wherein the traffic-to-link mapping element comprises a traffic-to-link mapping control field,
wherein the traffic-to-link mapping control field comprises a link mapping presence indicator subfield, wherein a first value of the link mapping presence indicator subfield indicates that a traffic identifier-to-link mapping field is present in the traffic-to-link mapping element, and
wherein the traffic identifier-to-link mapping field indicates that the first traffic identifier is mapped to the at least two links between the first multi-link device and the second multi-link device.

11. A multi-link device communication apparatus, comprising:
at least one memory configured to store program code; and
at least one processor configured to read the program code and operate as instructed by the program code, the program code comprising:
determining code configured to cause at least one of the at least one processor to determine that a first link transmitting traffic data between the first multi-link device and a second multi-link device is in a first state, wherein the first state indicates that the first link has channel quality lower than a threshold or is congested;
generating code configured to cause at least one of the at least one processor to generate, in response to the first link being in the first state, a first request frame requesting the second multi-link device to map a first traffic identifier of the traffic data to at least two links between the first multi-link device and the second multi-link device;
transmission code configured to cause at least one of the at least one processor to transmit the first request frame to the second multi-link device;
receiving code configured to cause at least one of the at least one processor to receive a first response frame returned by the second multi-link device in response to the first request frame; and
distribution code configured to cause at least one of the at least one processor to simultaneously transmit the traffic data over the at least two links based on the first response frame indicating that the second multi-link device accepts the first request frame, and update a mapping of the first traffic identifier from the first link to the at least two links, such that the traffic data is transmitted in parallel over the at least two links while the first link is in the first state.

12. The apparatus according to claim 11, wherein the first request frame comprises the first traffic identifier and a first mapping relationship that maps the first traffic identifier to the at least two links.

13. The apparatus according to claim 11, wherein the program code further comprises:
detection code configured to cause at least one of the at least one processor to detect, in response to the first link being in the first state, a state of at least one second link, wherein the at least one second link is an established link, other than the first link, between the first multi-link device and the second multi-link device; and
selection code configured to cause at least one of the at least one processor to select, from the at least one second link, at least one target second link that is in a second state or a third state; and
wherein the determining code is further configured to cause at least one of the at least one processor to determine the first link and the at least one target second link collectively as the at least two links.

14. The apparatus according to claim 13, wherein the second state is a state in which the at least one target second link has channel quality lower than the threshold or is congested; and
wherein the third state is a state in which the at least one target second link has channel quality higher than the threshold and is not congested.

15. The apparatus according to claim 11, wherein the program code further comprises:
monitoring code configured to cause at least one of the at least one processor to detect that the transmission of the traffic data over the at least two links does not meet a transmission requirement;
wherein the generating code is further configured to cause at least one of the at least one processor to generate a second request frame requesting the second multi-link device to map the first traffic identifier to at least three links between the first multi-link device and the second multi-link device;
wherein the receiving code is further configured to cause at least one of the at least one processor to receive a second response frame returned by the second multi-link device in response to the second request frame; and
wherein the distribution code is further configured to cause at least one of the at least one processor to simultaneously transmit the traffic data over the at least three links based on the second response frame indicating that the second multi-link device accepts the second request frame, and update the mapping of the first traffic identifier from the at least two links to the at least three links.

16. The apparatus according to claim 12, wherein the program code further comprises:
update code configured to cause at least one of the at least one processor to update, at the first multi-link device, a mapping relationship between the first traffic identifier and the first link to be the first mapping relationship, based on the first response frame indicating that the second multi-link device accepts the first request frame; and
wherein the distribution code is further configured to cause at least one of the at least one processor to continue to transmit the traffic data over the first link, based on the first response frame indicating that the second multi-link device rejects the first request frame.

17. The apparatus according to claim 12, wherein the update code is further configured to cause at least one of the at least one processor to:
update, at the first multi-link device, a mapping relationship between the first traffic identifier and the first link to be a second mapping relationship, based on the first response frame comprising the second mapping relationship determined by the second multi-link device and the first multi-link device accepting the second mapping relationship,
wherein the second mapping relationship is either a mapping relationship that maps the first traffic identifier to the at least two links and is determined by the second multi-link device based on the first request frame, or a mapping relationship obtained by the second multi-link device modifying the first mapping relationship.

18. The apparatus according to claim 11, wherein the first request frame comprises information indicating a change of the first traffic identifier to a second traffic identifier, wherein the second traffic identifier has a higher priority than the first traffic identifier.

19. The apparatus according to claim 18, wherein the program code further comprises:
priority code configured to cause at least one of the at least one processor to determine, based on a binding relationship between links and priorities, the links bound to the second traffic identifier to be the at least two links.

20. A non-transitory computer-readable storage medium, storing computer code which, when executed by at least one processor, causes the at least one processor to at least:
determine that a first link transmitting traffic data between the first multi-link device and a second multi-link device is in a first state, wherein the first state indicates that the first link has channel quality lower than a threshold or is congested;
generate, in response to the first link being in the first state, a first request frame requesting the second multi-link device to map a first traffic identifier of the traffic data to at least two links between the first multi-link device and the second multi-link device;
transmit the first request frame to the second multi-link device;
receive a first response frame returned by the second multi-link device in response to the first request frame; and
simultaneously transmit the traffic data over the at least two links based on the first response frame indicating that the second multi-link device accepts the first request frame, and update a mapping of the first traffic identifier from the first link to the at least two links, such that the traffic data is transmitted in parallel over the at least two links while the first link is in the first state.
